(19) United States
(12) Patent Application Publication
(10) Pub. No.: US 2026/0259733 A1
(43) Pub. Date: Sep. 3, 2026

(54) HARDWARE ASSISTED INSTRUCTION PREFETCH FOR FASTER PROCESSOR CLUSTER LOW POWER MODE (LPM) EXIT

(71) Applicant: QUALCOMM Incorporated, San Diego, CA (US)

(72) Inventors: Sharath Kumar NAGILLA, Hyderabad (IN); Maulik SHAH, Hyderabad (IN); Dinesh Kumar CHOUDHARY, Tonk (IN)

(21) Appl. No.: 19/067,331

(22) Filed: Feb. 28, 2025

(51) Int. Cl. G06F 9/30; G06F 9/355; G06F 9/38

(52) U.S. Cl. CPC G06F 9/30047; G06F 9/3557; G06F 9/3861

(57) ABSTRACT

Aspects of the disclosure are directed to a deterministic processor cluster instruction cache fetch. In accordance with one aspect, the disclosure includes restoring a system state information from a first random access memory (RAM); issuing a program counter (PC) state as a read address (RA) for a processor in a processor cluster system to execute at least one deterministic level two (L2) cache memory miss; retrieving a memory state data including one or more stored instructions from a main memory; and refilling a level two (L2) cache memory with the one or more stored instructions with the processor in a pre-operational state.

### TECHNICAL FIELD

This disclosure relates generally to the field of information processing systems, and, in particular, to instruction prefetching in an information processing system.

### BACKGROUND

An information processing system with a plurality of processing engines and memory devices may operate a plurality of modes, depending on the current service demand. A low power mode (LPM) may be used when service demand is low and dc power consumption needs to be minimized. A challenge for a mode transition from low power mode to an operational mode is higher latency. Thus, a more rapid mode transition from low power mode is desired with a plurality of processor clusters.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a deterministic processor cluster instruction cache fetch. Accordingly, the present disclosure discloses a method including: restoring a system state information from a first random access memory (RAM); issuing a program counter (PC) state as a read address (RA) for a processor in a processor cluster system to execute at least one deterministic level two (L2) cache memory miss; retrieving a memory state data including one or more stored instructions from a main memory; and refilling a level two (L2) cache memory with the one or more stored instructions with the processor in a pre-operational state.

Another aspect of the disclosure provides an apparatus including: a processor configured to execute at least one deterministic level 2 (L2) cache memory miss; and a level 2 (L2) cache memory coupled to the processor, the L2 cache memory configured to be refilled with one or more stored instructions with the processor in a pre-operational state.

Another aspect of the disclosure provides a non-transitory computer-readable medium storing computer executable code, operable on a device including at least one processor and at least one memory coupled to the at least one processor, wherein the at least one processor is configured to implement a deterministic processor cluster instruction cache fetch, the computer executable code including: instructions for causing a computer to restore a system state information from a first random access memory (RAM); instructions for causing the computer to issue a program counter (PC) state as a read address (RA) for a processor in a processor cluster system to execute at least one deterministic level two (L2) cache memory miss; instructions for causing the computer to retrieve a memory state data including one or more stored instructions from a main memory; and instructions for causing the computer to refill a level two (L2) cache memory with the one or more stored instructions with the processor in a pre-operational state.

These and other aspects of the present disclosure will become more fully understood upon a review of the detailed description which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example of a plurality of processor clusters with a hierarchy of cache memories.

FIG. 3 illustrates an example of a first processor instruction cache fetch operation.

FIG. 4 illustrates an example processor instruction cache fetch table.

FIG. 5 illustrates an example of a processor low power mode (LPM) entry sequence.

FIG. 6 illustrates an example of a cluster low power mode (LPM) entry sequence.

FIG. 7 illustrates an example of a first processor low power mode (LPM) exit sequence.

FIG. 8 illustrates an example of a first cluster low power mode (LPM) exit sequence.

FIG. 9 illustrates an example of a second processor low power mode (LPM) exit sequence.

FIG. 10 illustrates an example of a second cluster low power mode (LPM) exit sequence.

FIG. 11 illustrates an example of a second processor instruction cache fetch operation.

FIG. 12 illustrates an example flow diagram to implement a deterministic processor cluster instruction cache fetch.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), uses multiple levels of coordination or synchronization. In one example, a slice may include a processing engine (i.e., a subset of the computing system) as well as associated memory units and other peripheral devices. In one example, execution of an application may be decomposed into a workload which is executed by multiple slices or multiple processing engines.

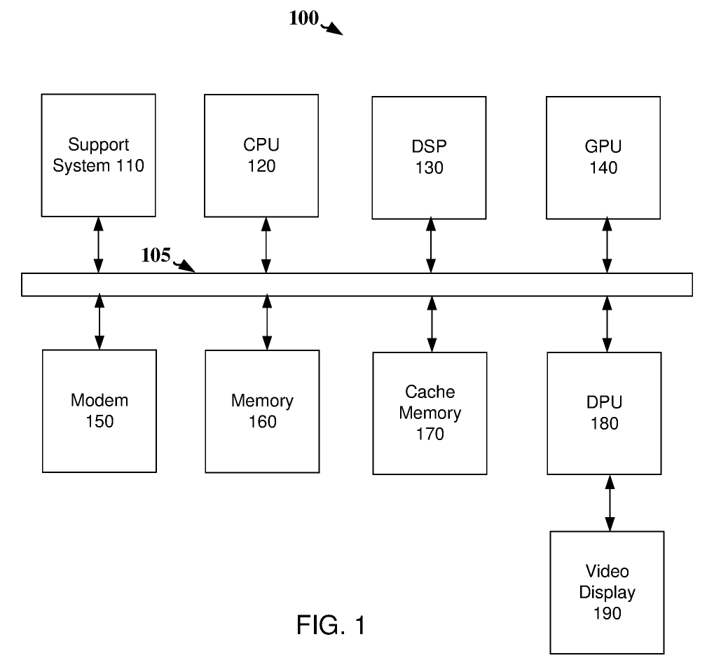

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information.

In one example, the CPU 120 may serve as a controller or a microcontroller of other processing engines. In one example, the controller or microcontroller may reallocate tasks from one processing engine to another. In one example, the controller or microcontroller may determine if a baseline workload partition should be reallocated using machine learning (ML) monitoring of system on a chip (SOC) temperatures.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SOC). In one example, the SOC may include the central processing unit (CPU) 120 and other processing engines such as the DSP 130 or the GPU 140. The SOC may also include the memory 160 and the cache memory 170.

In one example, the information processing system 100 may be part of a wireless device in a wireless communication system. For example, the wireless communication system may conform to a wireless network protocol such as 4G LTE (long term evolution), 5G NR (new radio), etc.

In one example, an information processing system may include a plurality of cache memories (e.g., level 2 (L2) cache) each with a memory capacity of up to 16 Megabytes (MB). In one example, a state transition from a last processor power down state to a cluster power down state may result in a cache memory content flush (i.e., erasure). In one example, a cluster wake up from the cluster power down state may incur a relatively long latency (i.e., time delay), for example, a 2 msec latency. For example, increasing usage of a cluster low power mode (LPM) may result in increased warmup latency. In one example, a warm-up instruction fetch from a next level cache memory (e.g., system last level cache control (LLCC) or double data rate (DDR) memory) may adversely impact overall processing engine wakeup latency durations.

In one example, the information processing system may allow a faster exit from a processor cluster LPM. In one example, the information processing system may operate with a reduced cache warmup time.

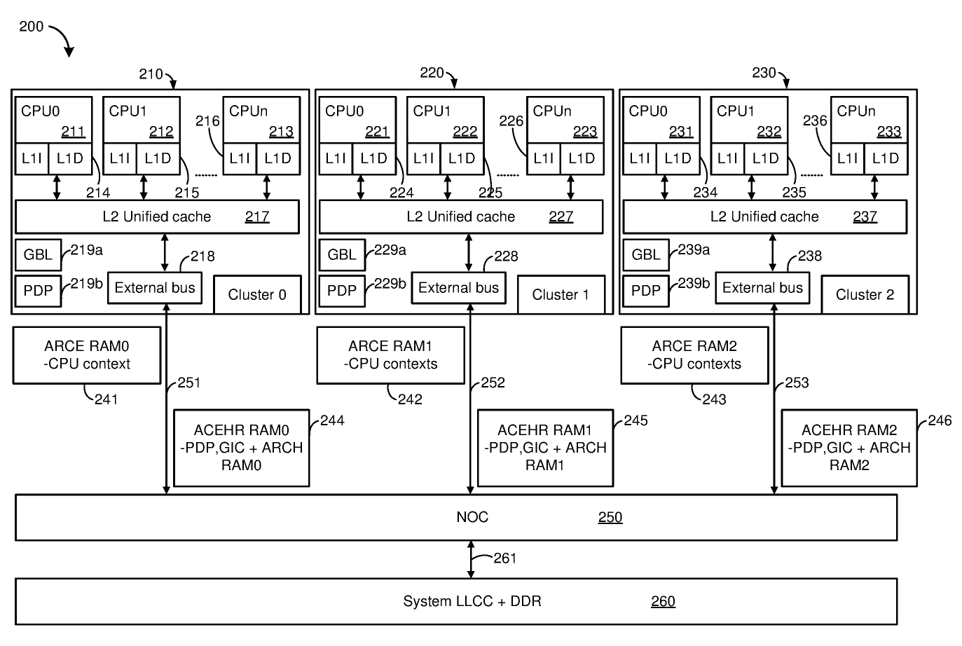

FIG. 2 illustrates an example of a plurality of processor clusters 200 with a hierarchy of cache memories. In one example, the plurality of processor clusters 200 includes a first processor cluster 210, a second processor cluster 220 and a third processor cluster 230. In one example, the first processor cluster 210 includes a first processor 211 with a first level one (L1) cache memory 214, a second processor 212 with a second L1 cache memory 215 and a third processor 213 with a third L1 cache memory 216. In one example, the first processor cluster 210 also includes a first L2 cache memory 217 connected to a first external bus interface 218. In one example, the first processor cluster 210 also includes a first global (GBL) unit 219a and a first power management and debug processor (PDP) 219b. In one example, the first GBL unit 219a handles debugging, power management, cloud control, etc.

In one example, the second processor cluster 220 includes a fourth processor 221 with a fourth level one (L1) cache memory 224, a fifth processor 222 with a fifth L1 cache memory 225 and a sixth processor 223 with a sixth L1 cache memory 226. In one example, the second processor cluster 220 also includes a second L2 cache memory 227 connected to a second external bus interface 228. In one example, the second processor cluster 220 also includes a second GBL 229a and a second PDP 229b.

In one example, the third processor cluster 230 includes a seventh processor 231 with a seventh level one (L1) cache memory 234, an eighth processor 232 with an eighth L1 cache memory 235 and a ninth processor 233 with a ninth L1 cache memory 236. In one example, the third processor cluster 230 also includes a third L2 cache memory 237 connected to a third external bus interface 238. In one example, the third processor cluster 230 also includes a third GBL 239a and a third PDP 239b.

In one example, the plurality of processor clusters 200 includes a first CPU context random access memory (RAM) 241, a second CPU context RAM 242 and a third CPU context RAM 243. In one example, the plurality of processor clusters 200 also includes a first data RAM 244, a second data RAM 245 and a third data RAM 246.

In one example, the first processor cluster 210, the second processor cluster 220 and the third processor cluster are connected to a network on a chip (NOC) 250 via a first databus 251, a second databus 252 and a third databus 253, respectively. In one example, the NOC 250 is connected to a system last level cache controller (LLCC) and double data rate (DDR) memory unit 260 via a system databus 261.

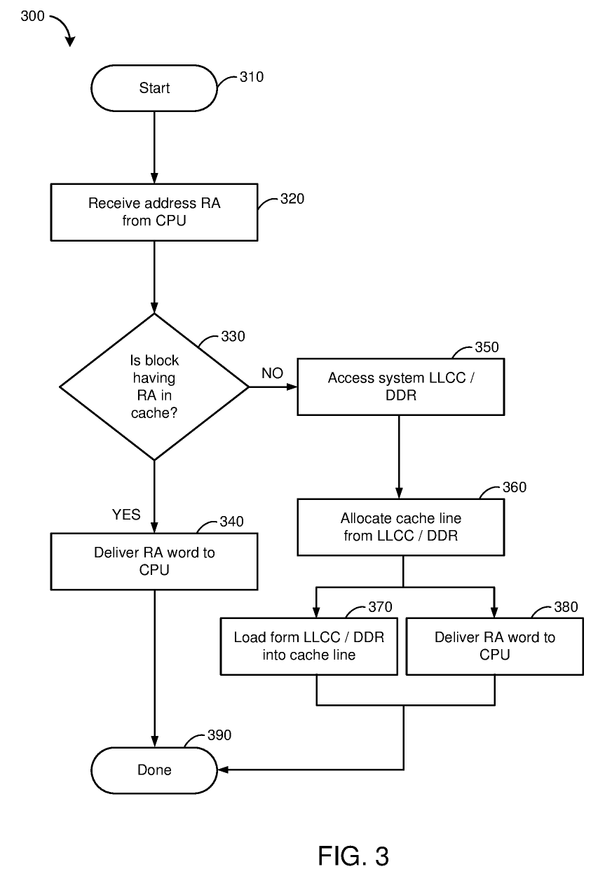

FIG. 3 illustrates an example of a first processor instruction cache fetch operation 300. In one example, commence cache fetch operation at a start block 310. In one example, receive a read address (RA) from a processor in block 320. In one example, determine if the RA indexes data in a cache memory in block 330. If yes, proceed to block 340. If no, proceed to block 350.

In block 340, retrieve a data word indexed by the RA from cache memory and deliver the data word to the processor. In block 350, access a system LLCC with DDR memory. In block 360, allocate a cache line from the system LLCC with DDR memory. In block 370, load a data word from the system LLCC with DDR memory into the cache line. In block 380, deliver the data word indexed by the RA to the processor (e.g., CPU). In block 390, terminate the cache fetch operation.

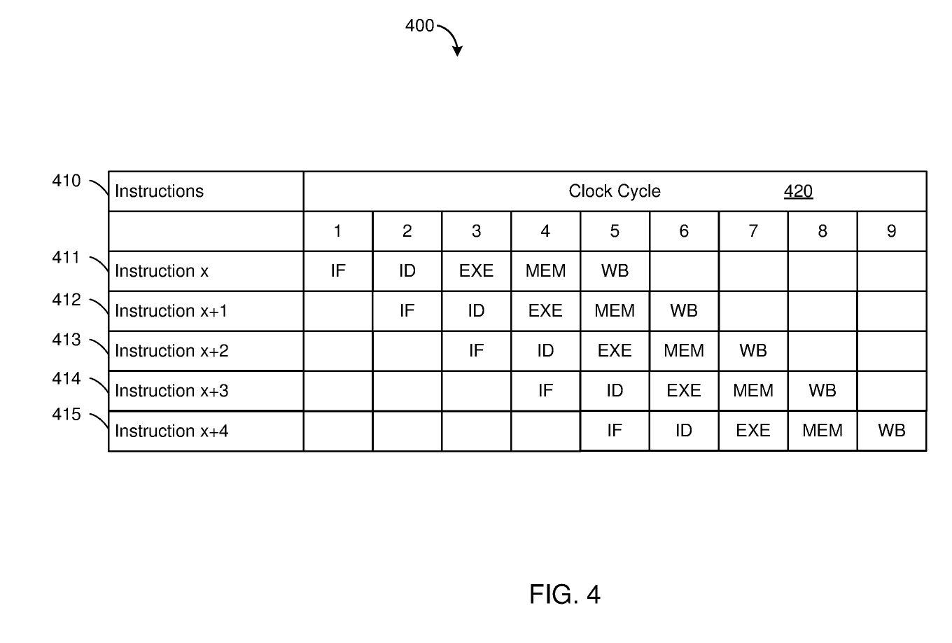

FIG. 4 illustrates an example processor instruction cache fetch table 400. In one example, the processor instruction cache fetch table 400 includes a plurality of instructions 410 with a first instruction 411, a second instruction 412, a third instruction 413, a fourth instruction 414 and a fifth instruction 415. In one example, processing of the plurality of instructions 410 is performed on parallel stages which operate on different parts of the plurality of instructions 410. For example, the time needed to move an instruction from one stage to another stage defines a machine cycle or clock period for a processor. For example, a quantity of instruction pipelines varies per processor.

In one example, a cache line is a basic unit of cache memory storage with a plurality of data bytes or data words. In one example, a cache hit denotes that an addressed data word is available in cache memory. In one example, a cache miss denotes that an addressed data word is not available in cache memory (i.e., is available in a higher level memory). In one example, an instruction fetch (IF) is speculative where instruction cache lines are allocated into a L2 cache memory when fetched from an external memory (e.g., a system LLCC with DDR memory). In one example, data cache lines are allocated into the L2 cache memory when evicted from an L1 cache memory. Referring to FIG. 4, in one example, ID is an instruction decode, EXE is an instruction execute, MEM is a memory operation and WB is a write back.

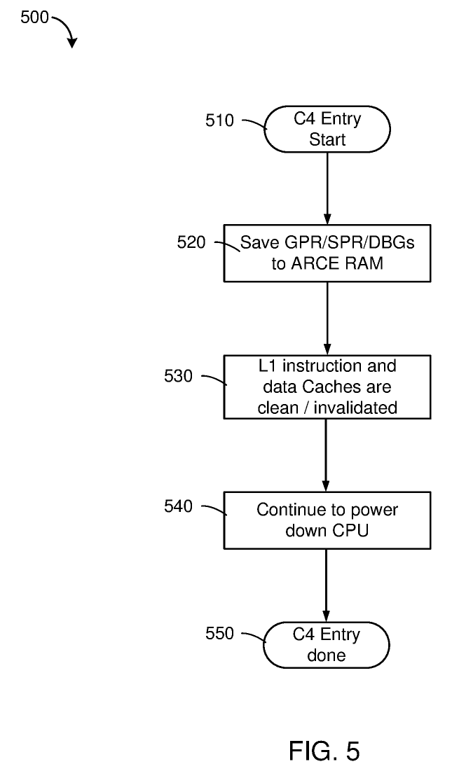

FIG. 5 illustrates an example of a processor low power mode (LPM) entry sequence 500. In one example, the processor low power mode (LPM) entry sequence 500 commences with a processor LPM down entry in block 510. In block 520, save register contents to a processor context random access memory (RAM). For example, the register contents may be from a general purpose register (GPR), a special purpose register (SPR), a debug (DBG) register, etc. In one example, the GPR is a general purpose register for generic data. In one example, the SPR is a special purpose register for program counter(s) (PC), stack pointer (SP), etc. In block 530, clean and invalidate a plurality of L1 cache memories. In one example, the plurality of L1 cache memories includes an L1 data cache memory and an L1 instruction cache memory. In block 540, continue to power down a processor (e.g., CPU). In block 550, the processor LPM entry sequence is complete.

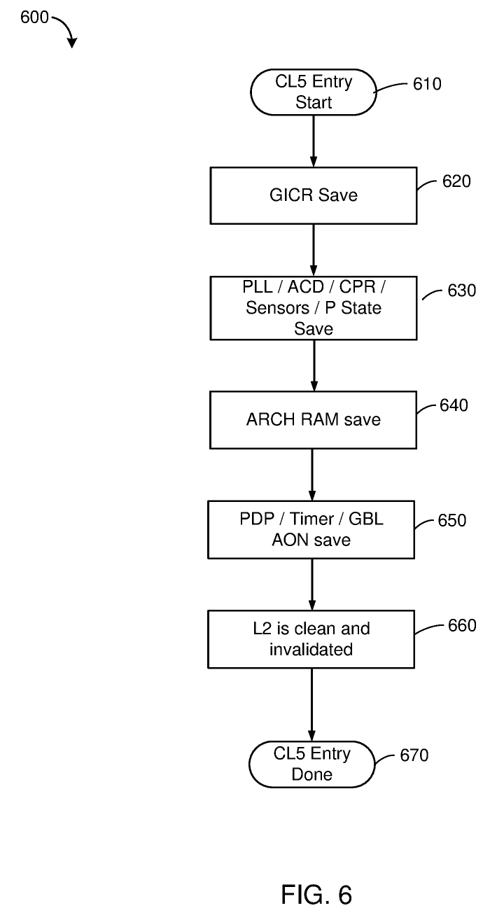

FIG. 6 illustrates an example of a cluster low power mode (LPM) entry sequence 600. In one example, the cluster LPM entry sequence 600 commences with a cluster PLM entry in block 610. In block 620, save register contents to a RAM. In one example, the register contents may be from a general interrupt control register (GICR). In block 630, save processor state information into the RAM. In one example, the processor state information may include state data from a phase locked loop (PLL), an adaptive clock division (ACD) circuit, a core power reduction (CPR) register, a plurality of sensors, etc. In block 640, preserve system state information in a system RAM. In block 650, save miscellaneous state information in an always on (AON) memory. In one example, miscellaneous state information may include state data from a power management and debug processor (PDP), a timer, a global (GBL) unit, etc. In block 660, clean and invalidate a plurality of L2 cache memories. In block 670, the first cluster LPM entry sequence is complete.

In one example, the first cluster LPM entry sequence 600 requires a much longer time duration to complete than the first processor LPM entry sequence 500. For example, the first cluster LPM entry sequence 600 may take up to 2500 usec to complete and the first processor LPM entry sequence 500 may take up to 150 usec to complete.

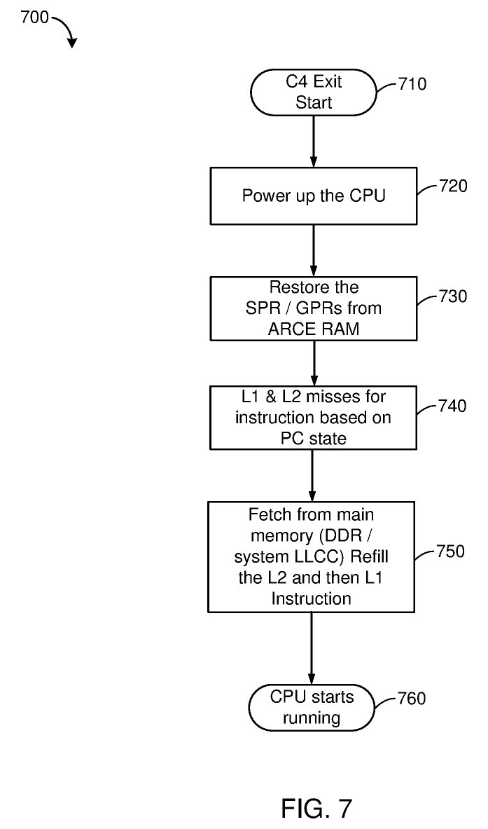

FIG. 7 illustrates an example of a first processor low power mode (LPM) exit sequence 700. In one example, the first processor low power mode (LPM) exit sequence 700 commences with a processor LPM down exit in block 710. In block 720, power up a processor (e.g., CPU). In block 730, restore register contents from a processor context random access memory (RAM). For example, the register contents may be from a general purpose register (GPR), a special purpose register (SPR), a debug (DBG) register, etc. In block 740, attempt cache memory access with instructions based on a processor state. In one example, the cache memory access is an access for L1 cache memory and L2 cache memory. In block 750, retrieve memory state data from main memory (e.g., DDR memory, system last level cache controller (LLCC), etc.) and refill the L2 cache memory and the L1 cache memory with stored instructions. In block 760, commence processor (e.g., CPU) operation and continue with retrieved cache memory operation.

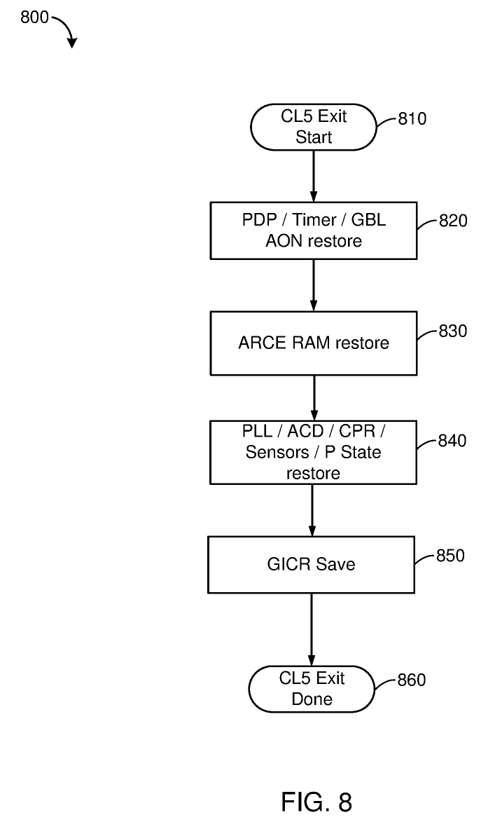

FIG. 8 illustrates an example of a first cluster low power mode (LPM) exit sequence 800. In one example, the first cluster LPM exit sequence 800 commences with a cluster LPM down exit in block 810. In block 820, restore miscellaneous state information from an AON memory. In one example, miscellaneous state information may include state data from a power management and debug processor (PDP), a timer, a global (GBL) unit, etc. In block 830, restore system state information from a system RAM. In one example, system state information includes general purpose register (GPR) contents, program counter (PC) state, etc. In block 840, restore processor state information from a RAM. In one example, the processor state information may include state data from a phase locked loop (PLL), an adaptive clock division (ACD) circuit, a core power reduction (CPR) register, a plurality of sensors, etc. In block 850, retrieve register contents from a RAM. In one example, the register contents may be from a general interrupt control register (GICR). In block 860, the first cluster LPM exit sequence 800 is complete.

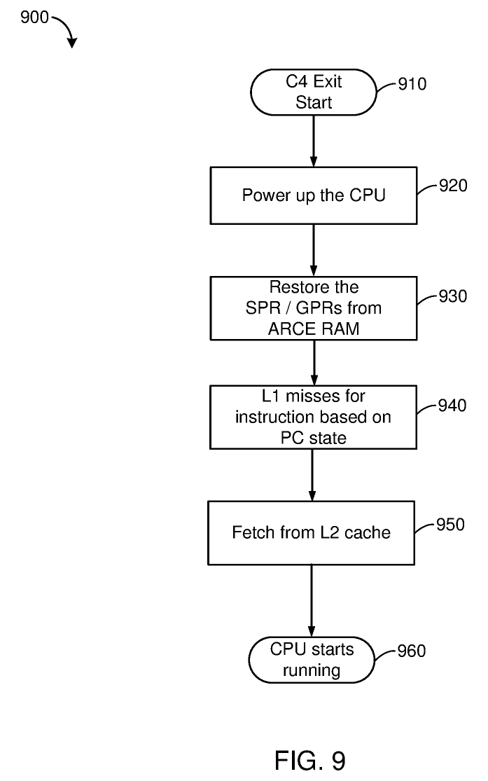

FIG. 9 illustrates an example of a second processor low power mode (LPM) exit sequence 900. In block 910, commence the second processor low power mode (LPM) exit sequence. In block 920, power up a processor (e.g., CPU). In block 930, restore register contents from a processor context random access memory (RAM). For example, the register contents may be from a general purpose register (GPR), a special purpose register (SPR), a debug (DBG) register, etc. In block 940, attempt cache memory access with instructions based on a processor state. In one example, the cache memory access is an access for L1 cache memory. In block 950, retrieve memory state data from L2 cache memory. In block 960, commence processor (e.g., CPU) operation and continue with retrieved cache memory operation. In one example, stored instructions are available in L2 cache memory.

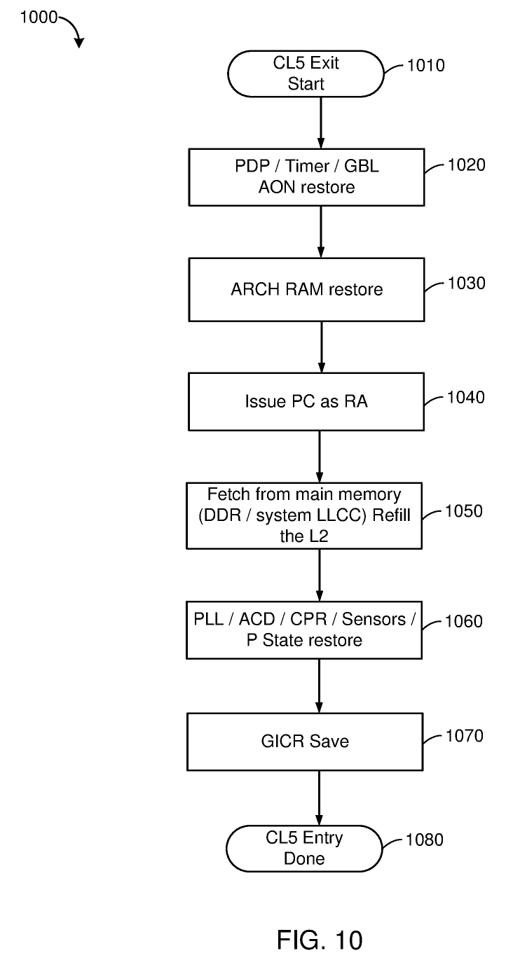

FIG. 10 illustrates an example of a second cluster low power mode (LPM) exit sequence 1000. In block 1010, commence a cluster LPM down exit. In block 1020, restore miscellaneous state information from an AON memory. In one example, miscellaneous state information may include state data from a power management and debug processor (PDP), a timer, a global (GBL) unit, etc. In block 1030, restore system state information from a system RAM. In block 1040, issue a program counter (PC) as a read address (RA). In block 1050, retrieve memory state data from main memory (e.g., DDR memory, system last level cache controller (LLCC), etc.) and refill the L2 cache memory with stored instructions. In block 1060, restore processor state information from a RAM. In one example, the processor state information may include state data from a phase locked loop (PLL), an adaptive clock division (ACD) circuit, a core power reduction (CPR) register, a plurality of sensors, etc. In block 1070, retrieve register contents from a RAM. In one example, the register contents may be from a general interrupt control register (GICR). In block 1080, the second cluster LPM exit sequence 1000 is complete. In one example, the program counter (PC) is a processor register which maintains an address for the next instruction to be executed. For example, the PC is incremented after each fetch of an instruction from memory.

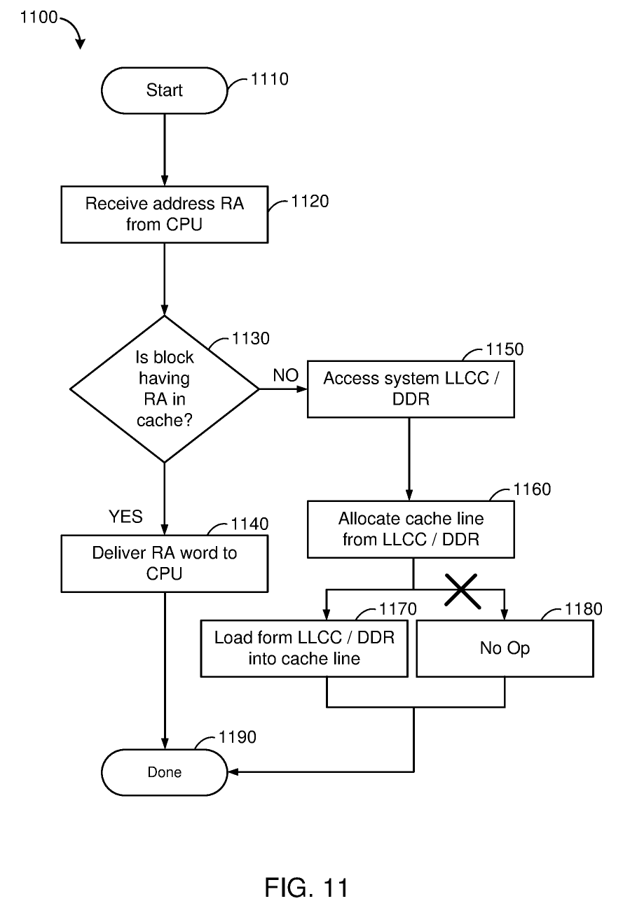

FIG. 11 illustrates an example of a second processor instruction cache fetch operation 1100. In one example, commence cache fetch operation at a start block 1110. In one example, receive a read address (RA) from a processor in block 1120. In one example, determine if the RA indexes data in a cache memory in block 1130. If yes, proceed to block 1140. If no, proceed to block 1150.

In block 1140, retrieve a data word indexed by the RA from cache memory and deliver the data word to the processor (e.g., CPU). In block 1150, access a system LLCC with DDR memory. In block 1160, allocate a cache line from the system LLCC with DDR memory. In block 1170, load an instruction word from the system LLCC with DDR memory into a cache line of an L2 cache memory. In block 1180, execute a null operation (i.e., No Op) prior to processor commencing operation. In block 1190, terminate the cache fetch operation.

In one example, the second processor instruction cache fetch operation 1100 loads an instruction word into the level two (L2) cache memory prior to commencement of processor operation.

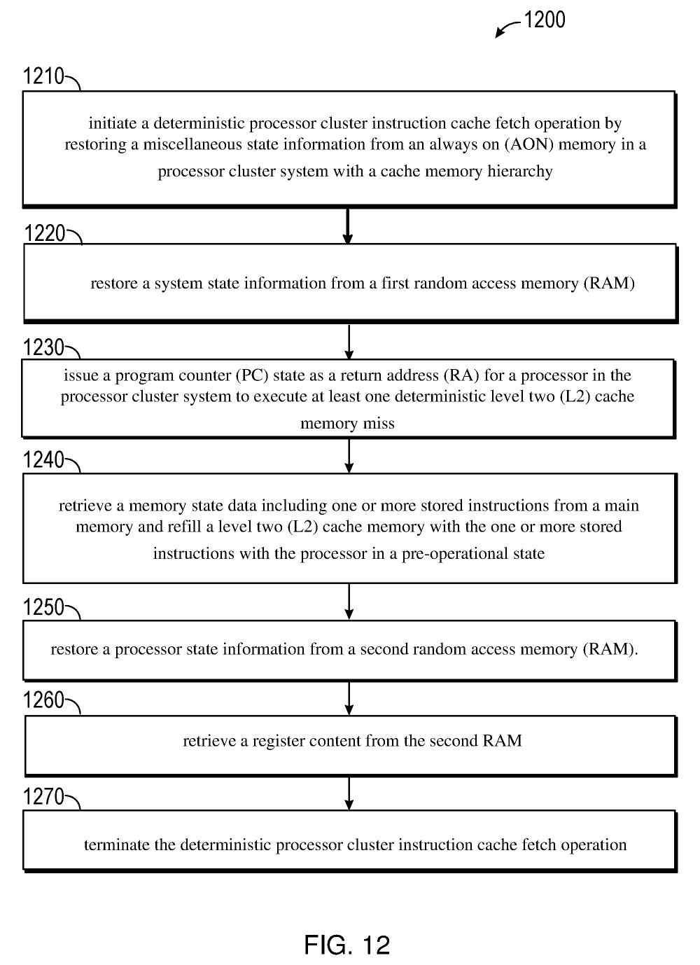

FIG. 12 illustrates an example flow diagram 1200 to implement a deterministic processor cluster instruction cache fetch. In block 1210, initiate a deterministic processor cluster instruction cache fetch operation by restoring a miscellaneous state information from an always on (AON) memory in a processor cluster system with a cache memory hierarchy. That is, in one example, a deterministic processor cluster instruction cache fetch operation is initiated by restoring a miscellaneous state information from an always on (AON) memory in a processor cluster system with a cache memory hierarchy.

In one example, the cache memory hierarchy includes a plurality of level one (L1) cache memories and a plurality of level two (L2) cache memories. In one example, miscellaneous state information may include state data from a power management and debug processor (PDP), a timer, a global (GBL) unit, etc. In one example, a level one (L1) cache memory stores local processor data and instruction. In one example, local processor data and instruction are data and instruction exclusive to one processor. In one example, a level two (L2) cache memory stores local processor cluster data and instruction. In one example, local processor cluster data and instruction are data and instruction exclusive to one processor cluster.

In block 1220, restore a system state information from a first random access memory (RAM). That is, in one example, a system state information is restored from a first random access memory (RAM). In one example, system state information includes a general purpose register (GPR) content, or a program counter (PC) state, etc.

In block 1230, issue a program counter (PC) state as a read address (RA) for a processor in the processor cluster system to execute at least one deterministic level two (L2) cache memory miss. That is, in one example, a program counter (PC) state is issued as a read address (RA) for a processor in the processor cluster system to execute at least one deterministic level two (L2) cache memory miss. In one example, the issuing of the PC state allocates at least one cache line from a system last level cache controller (LLCC) and a main memory (e.g., DDR memory). In one example, the processor is in a pre-operational state.

In block 1240, retrieve a memory state data including one or more stored instructions from a main memory (e.g., a double data rate (DDR) memory, system last level cache controller (LLCC), etc.) and refill a level two (L2) cache memory with the one or more stored instructions with the processor in a pre-operational state. That is, in one example, a memory state data including one or more stored instructions is retrieved from the main memory (e.g., a double data rate (DDR) memory, system last level cache controller (LLCC), etc.) and a level two (L2) cache memory is refilled with the one or more stored instructions with the processor in a pre-operational state.

In block 1250, restore a processor state information from a second random access memory (RAM). That is, in one example, a processor state information is restored from a second random access memory (RAM). In one example, the processor state information may include state data from a phase locked loop (PLL), an adaptive clock division (ACD) circuit, a core power reduction (CPR) register, a plurality of sensors, etc. In one example, the second RAM is the same as the first RAM.

In block 1260, retrieve a register content from the second RAM. That is, in one example, a register content is retrieved from the second RAM. In one example, the register contents may be from a general interrupt control register (GICR).

In block 1270, terminate the deterministic processor cluster instruction cache fetch operation. That is, in one example, the deterministic processor cluster instruction cache fetch operation is terminated. In one example, each of the steps of FIG. 12 may be performed by one of the following: a processing engine, a processor, a controller, a microcontroller, a microprocessor, a central processing unit (CPU), a graphics processing unit (GPU), a digital signal processor (DSP), firmware and/or in combination with software, etc.

In one example, the deterministic processor cluster instruction cache fetch operation fetches instructions during a cluster LPM exit sequence deterministically, rather than using a speculative fetch. For example, a processor does not perceive L2 cache memory instruction cache misses, and the L1 cache memory instruction cache misses allow data to be ready in the L2 cache memory. For example, parallelization of L2 cache memory refilling with the cluster LPM exit sequence results in a more rapid cluster LPM exit sequence.

In one example, a hardware finite state machine (FSM) reads a program counter (PC) value from a system RAM. For example, the PC value issues as a read address (RA) to the L2 cache memory. For example, a PC+L2 cache line size also issues to fill a next cache line as well. In one example, the cache line is maintained in L2 cache memory only and is not delivered to the processor (e.g., while the processor is still powering up).

In one example, the deterministic processor instruction cache fetch operation allows the L2 cache memory to be ready with required instructions and data for subsequent operation. In one example, overall LPM exit latency is reduced and the operation may be extended to a plurality of cluster LPM exit sequences.

The disclosure includes a method including: restoring a system state information from a first random access memory (RAM); issuing a program counter (PC) state as a read address RA) for a processor in a processor cluster system to execute at least one deterministic level two (L2) cache memory miss; retrieving a memory state data including one or more stored instructions from a main memory; and refilling a level two (L2) cache memory with the one or more stored instructions with the processor in a pre-operational state.

In one example, the main memory is one of the following: a double data rate (DDR) memory or a system last level cache controller (LLCC). In one example, the system state information includes one or more of the following: a general purpose register (GPR) content or the program counter (PC) state.

In one example, the method further includes using the program counter (PC) to allocate at least one cache line from a system last level cache controller (LLCC) and the main memory. In one example, the method further includes restoring a processor state information from a second random access memory (RAM). In one example, the processor state information includes one or more of the following: a state data from a phase locked loop (PLL), an adaptive clock division (ACD) circuit, a core power reduction (CPR) register, or a plurality of sensors.

In one example, the method further includes retrieving a register content from the second RAM. In one example, the method further includes initiating a deterministic processor cluster instruction cache fetch operation by restoring a miscellaneous state information from an always on (AON) memory in the processor cluster system with a cache memory hierarchy. In one example, the miscellaneous state information includes one or more of the following: a state data from a power management and debug processor (PDP), a timer, or a global (GBL) unit. In one example, the method further includes terminating the deterministic processor cluster instruction cache fetch operation.

The disclosure includes an apparatus including: a processor configured to execute at least one deterministic level 2 (L2) cache memory miss; and a level 2 (L2) cache memory coupled to the processor, the L2 cache memory configured to be refilled with one or more stored instructions with the processor in a pre-operational state.

In one example, the apparatus further includes a first random access memory (RAM) configured to store a system state information. In one example, the system state information includes one or more of the following: a general purpose register (GPR) content or the program counter (PC) state.

In one example, the apparatus further includes a second random access memory (RAM) configured to store processor state information. In one example, the processor state information includes one or more of the following: a state data from a phase locked loop (PLL), an adaptive clock division (ACD) circuit, a core power reduction (CPR) register, or a plurality of sensors.

In one example, the apparatus further includes a level 1 (L1) cache memory coupled to the processor, the L1 cache memory configured to store a local processor data and instruction. In one example, the L2 cache memory is further configured to store a local processor cluster data and instruction.

The disclosure includes a non-transitory computer-readable medium storing computer executable code, operable on a device including at least one processor and at least one memory coupled to the at least one processor, wherein the at least one processor is configured to implement a deterministic processor cluster instruction cache fetch, the computer executable code including: instructions for causing a computer to restore a system state information from a first random access memory (RAM); instructions for causing the computer to issue a program counter (PC) state as a read address (RA) for a processor in a processor cluster system to execute at least one deterministic level two (L2) cache memory miss; instructions for causing the computer to retrieve a memory state data including one or more stored instructions from a main memory; and instructions for causing the computer to refill a level two (L2) cache memory with the one or more stored instructions with the processor in a pre-operational state.

In one example, the non-transitory computer-readable medium further includes: instructions for causing the computer to restore a processor state information from a second random access memory (RAM); and instructions for causing the computer to retrieve a register content from the second RAM. In one example, the non-transitory computer-readable medium further includes: instructions for causing the computer to initiate a deterministic processor cluster instruction cache fetch operation by restoring a miscellaneous state information from an always on (AON) memory in the processor cluster system with a cache memory hierarchy.

In one aspect, one or more of the steps for providing a deterministic processor cluster instruction cache fetch in FIG. 12 may be executed by one or more processors which may include hardware, software, firmware, etc. The one or more processors, for example, may be used to execute software or firmware needed to perform the steps in the flow diagram of FIG. 12. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
restoring a system state information from a first random access memory (RAM);
issuing a program counter (PC) state as a read address (RA) for a processor in a processor cluster system to execute at least one deterministic level two (L2) cache memory miss;
retrieving a memory state data including one or more stored instructions from a main memory; and
refilling a level two (L2) cache memory with the one or more stored instructions with the processor in a pre-operational state.

2. The method of claim 1, wherein the main memory is one of the following: a double data rate (DDR) memory or a system last level cache controller (LLCC).

3. The method of claim 1, wherein the system state information includes one or more of the following: a general purpose register (GPR) content or the program counter (PC) state.

4. The method of claim 1, further comprising using the program counter (PC) to allocate at least one cache line from a system last level cache controller (LLCC) and the main memory.

5. The method of claim 1, further comprising restoring a processor state information from a second random access memory (RAM).

6. The method of claim 5, wherein the processor state information includes one or more of the following: a state data from a phase locked loop (PLL), an adaptive clock division (ACD) circuit, a core power reduction (CPR) register, or a plurality of sensors.

7. The method of claim 5, further comprising retrieving a register content from the second RAM.

8. The method of claim 7, further comprising initiating a deterministic processor cluster instruction cache fetch operation by restoring a miscellaneous state information from an always on (AON) memory in the processor cluster system with a cache memory hierarchy.

9. The method of claim 8, wherein the miscellaneous state information includes one or more of the following: a state data from a power management and debug processor (PDP), a timer, or a global (GBL) unit.

10. The method of claim 8, further comprising terminating the deterministic processor cluster instruction cache fetch operation.

11. An apparatus comprising:
a processor configured to execute at least one deterministic level 2 (L2) cache memory miss; and
a level 2 (L2) cache memory coupled to the processor, the L2 cache memory configured to be refilled with one or more stored instructions with the processor in a pre-operational state.

12. The apparatus of claim 11, further comprising a first random access memory (RAM) configured to store a system state information.

13. The apparatus of claim 12, wherein the system state information includes one or more of the following: a general purpose register (GPR) content or the program counter (PC) state.

14. The apparatus of claim 12, further comprising a second random access memory (RAM) configured to store processor state information.

15. The apparatus of claim 14, wherein the processor state information includes one or more of the following: a state data from a phase locked loop (PLL), an adaptive clock division (ACD) circuit, a core power reduction (CPR) register, or a plurality of sensors.

16. The apparatus of claim 11, further comprising a level 1 (L1) cache memory coupled to the processor, the L1 cache memory configured to store a local processor data and instruction.

17. The apparatus of claim 16, wherein the L2 cache memory is further configured to store a local processor cluster data and instruction.

18. A non-transitory computer-readable medium storing computer executable code, operable on a device comprising at least one processor and at least one memory coupled to the at least one processor, wherein the at least one processor is configured to implement a deterministic processor cluster instruction cache fetch, the computer executable code comprising:
instructions for causing a computer to restore a system state information from a first random access memory (RAM);
instructions for causing the computer to issue a program counter (PC) state as a read address (RA) for a processor in a processor cluster system to execute at least one deterministic level two (L2) cache memory miss;
instructions for causing the computer to retrieve a memory state data including one or more stored instructions from a main memory; and
instructions for causing the computer to refill a level two (L2) cache memory with the one or more stored instructions with the processor in a pre-operational state.

19. The non-transitory computer-readable medium of claim 18, further comprising:
instructions for causing the computer to restore a processor state information from a second random access memory (RAM); and
instructions for causing the computer to retrieve a register content from the second RAM.

20. The non-transitory computer-readable medium of claim 19, further comprising instructions for causing the computer to initiate a deterministic processor cluster instruction cache fetch operation by restoring a miscellaneous state information from an always on (AON) memory in the processor cluster system with a cache memory hierarchy.
